(19) United States
(12) Patent Application Publication
(10) Pub. No.: US 2013/0182444 A1
(43) Pub. Date: Jul. 18, 2013

(54) LED HEAD AND PHOTON EXTRACTOR

(71) Applicants: Jens Østergaard Wagenblast Stubbe, Roskilde (DK); David Svensson, Lund (SE)

(72) Inventors: Jens Østergaard Wagenblast Stubbe, Roskilde (DK); David Svensson, Lund (SE)

(73) Assignee: BLACKBRITE APS, Roskilde (DK)

(21) Appl. No.: 13/582,970

(22) PCT Filed: Mar. 7, 2011
(86) PCT No.: PCT/DK2011/050071

§ 371 Date: Dec. 17, 2012

(30) Foreign Application Priority Data
Mar. 6, 2010 (DK) PA 2010 00177

(51) Int. Cl. F21V 13/04; F21V 7/00

(52) U.S. Cl. CPC F21V 13/04; F21V 7/00; F21V 7/0091
USPC 362/309; 362/296.01; 362/296.09

(57) ABSTRACT

The invention concerns a semiconductor based light source comprising a back part, a front side and at least one semiconductor chip having an emitting surface, at least one reflective optical element being arranged below said at least one semiconductor chip, a material with low refractive index being disposed on a side of said reflective optical element facing said front side, wherein said semiconductor based light source comprises on said front side a compound material with high refractive index having at least one diffractive optical element embedded therein, such as to direct light incident on said diffractive optical element towards preferred directions.

### FIELD OF THE INVENTION

The present invention relates in a first aspect to semiconductor light sources, particularly light emitting diodes (LED), and has particular applicability in the field of packaged light emitting diodes (LED). In a second aspect the present invention relates to a heat transfer means for semiconductor devices.

### BACKGROUND

Generally, an LED consists of a chip of a semiconductor material, such as gallium arsenide (GAAS), gallium nitride (GAN), indium gallium nitride (INGAN) or the like, doped with impurities, such as to create a so-called p-n junction in which a current flows from the p-side, or anode, to the n-side, or cathode, but not in the reverse direction.

Most materials used for LEDs have very high refractive indices. Hence, much light will be TIR and Fresnel reflected back into the material at the material/air surface interface. Thus, light extraction in LEDs is an important aspect of LED production, subject to much research and development.

Generally, LEDs emit light having wavelengths ranging from the infrared over the visible part of the electromagnetic spectrum to the ultraviolet, and even deep ultraviolet. In practice, a wide variety of LEDs have been manufactured emitting light having wavelengths in the range from about 1000 nm (infrared) to about 200 nm (deep ultraviolet).

LEDs are typically sold in a packaged form that includes a LED chip mounted on a metal header. The header has a reflective cup in which the LED die is mounted, and electrical leads connected to the LED die. The package further includes a molded transparent resin that encapsulates the LED die. The encapsulating resin typically has a nominally hemispherical front surface to partially collimate light emitted from the LED die.

Conventional LED packages emit light to air which cause photons inside the LED packages to remain trapped by total internal reflection (TIR) and Fresnel reflection and force heat inside the LED package to exit primarily through the backside of the LED package into attached heat sinks. LED lifetime decreases with temperature rise due to poor heat dissipation and recombination of photons to electrons which output phonons that ultimately converge to heat inside the LED chip. LED chips contacts the encapsulating resin, which in many cases have low thermal conductivity and in particular short wavelength LED's deteriorate the encapsulating resin over time in a way that increase absorption and adversely effect the emission of photons and the formation of internal heat.

For LED applications the output capacity in relation to energy input (Im/W), chip area (Im/chip-area) and cost of production and/or sale (Im/ [symbol] ) are important.

As used in the following as well as in the claims, the expressions “low n material”, “low n layer” and the like means a material or a layer with a low refractive index, where a low refractive index is intended to encompass refractive indices of 1.4 or lower.

As used in the following as well as in the claims, the expressions “compound high n material”, “high n layer” and the like means a material with a high refractive index, where a high refractive index is intended to encompass refractive indices of 1.5 or higher.

As used in the following as well as in the claims, the expression “material with a high thermal conductivity” is intended to encompass materials having thermal conductivities of 200 (W·m⁻¹·k⁻¹) or higher.

### BRIEF SUMMARY

The present invention aims in a first aspect at providing a semiconductor based light source that obviates or mitigates the abovementioned problems, and which has an improved output capacity and efficiency.

The present invention aims in a second aspect at providing a heat transfer means for a semiconductor device that obviates or mitigates the abovementioned problems at least as far as heat dissipation and heat conductivity is concerned.

According to a first aspect of the invention, the above objects are achieved by a semiconductor based light source comprising a back part, a front side and at least one semiconductor chip having an emitting surface, at least one reflective optical element being arranged below said at least one semiconductor chip, a material with low refractive index (low n material) being disposed on a side of said reflective optical element facing said front side, wherein said semiconductor based light source comprises on said front side a compound material with high refractive index (compound high n material) having at least one diffractive optical element embedded therein, such as to direct light incident on said diffractive optical element towards preferred directions.

Thereby, semiconductor based light source is provided in which the critical angle for emission of light from the emitting surface semiconductor chip to the surroundings is increased, which in turn increases the number of photons emitted per time unit, thereby achieving an increased and improved output capacity and thus efficiency of the semiconductor based light source.

Furthermore, the heat transfer through the surface of the semiconductor based light source is increased, thereby providing for improved heat dissipation and thus cooling of the semiconductor chip, which in turn contributes to increasing the efficiency of the semiconductor based light source.

According to a second aspect of the invention, the above objects are achieved by a heat transfer means for a semiconductor device, said heat transfer means being adapted to be arranged on a surface of a semiconductor device opposite an emitting or absorbing surface of said semiconductor device, and said heat transfer means being an anisotropic heat transfer means and comprising a compound material comprising materials with a high refractive index and a high thermal conductivity.

Thereby, a heat transfer means is provided with which the heat transfer through the surface of the semiconductor device is increased, thereby providing for improved heat dissipation and thus cooling of the semiconductor device in a particularly simple and reliable way. Furthermore such a heat transfer means is very cheap in production.

Further embodiments and advantages of the different aspects of the invention will be apparent from the respective dependent claims and from the detailed description below.

### BRIEF DESCRIPTION OF THE DRAWINGS

Throughout the specification, reference is made to the appended drawings, where like reference numerals designate like elements, and wherein:

FIG. 1 shows a semiconductor based light source according to a first aspect of the invention,

FIG. 2 shows a semiconductor based light source according to a first aspect of the invention mounted on a waveguide, and

FIG. 3 shows a heat transfer means according to a second aspect of the invention.

### DETAILED DESCRIPTION OF THE ILLUSTRATIVE EMBODIMENTS

In the text that follows, the various aspects of the invention will be illustrated by means of a preferred embodiment of a semiconductor device being a semiconductor light source in the form a light emitting diode (LED) package, preferably a high brightness light emitting diode (LED) package. Advantages associated therewith are disclosed amidst a discussion of related embodiments. This is so that the reader will more fully appreciate design details and variations of the claimed invention.

In FIG. 1, showing a preferred embodiment of semiconductor based light source according to the first aspect of the invention, a heat sink 10 is connected to a back part 5 of a LED package 15 comprising a LED chip 20 situated on top of a metallic mirror 25 connected electrically to the LED chip 20 through openings in a dielectric material with low refractive index, n, 30 (in the following denoted “low n material 30”) that induce total internal reflection (TIR) to reflect light back into the LED chip 20 as well as to a compound material with high refractive index, n, 35 (in the following denoted “compound high n material 35”) with an embedded diffractive optics element 40 beneath the LED package front side 45.

The heat sink 10 connects to the exterior through either the outer surface of the entire application where the LED package 15 is incorporated or internally in the entire application through convection to airflow.

The compound high n material 35 consists of a curable polymer such as epoxy, silicone or silane mixed with a high refractive material of high thermal and optionally also high electrical conductivity, such as particles of silicon carbide (SiC) and/or diamond, with particle sizes smaller than the wavelength of light emitted from the LED chip 20 such that the compound has a combined tunable refractive index that can be better matched to the LED chip 20 for optimum optical out coupling with no TIR or Fresnel entrapment of light inside the LED chip 20. The wavelength of light emitted from the LED chip 20 may, as described by way of introduction, generally be anywhere between 200 nm and 1000 nm, depending on the particular type of LED. Any curable polymer may be used in the high n material 35; typically curable polymers are cured by application of heat, e.g. thermosetting polymers, or a curable polymer may be cured by exposure to light, e.g. ultraviolet light. Curable polymers and their principles for curing are well known within the art. The diamond particles, e.g. diamond nano dust, can be Boron doped to enhance electric conductivity such that the LED chip 20 can be electrically connected via the compound high n material 35. The electric and thermal conductivity can be further enhanced by means of incorporating carbon nanotubes (CNT) in the compound. CNT has along the long axis high thermal and electric conductivity. CNT can be aligned with electric field lines by sending current through before and while the polymer is cured. Adding metal ions or transparent materials, such as Indium tin oxide (ITO), can further enhance the electric conductivity. Curing of the polymer can be achieved by short wavelength light, heat or the polymer can be blended as a two component-curing polymer. Boron doping of diamond creates diamonds that feature decreased optical transmission outside the blue spectrum which result in a favourable filtering of incident down converted white light that may be attenuated by absorbtion before entering into the LED chip 20 and thus creates less thermal management issues.

The embedded diffractive optics element 40 can be double-sided to advance the beam shaping properties and more than one embedded diffractive optics element 40 can be superposed. Positioning of the embedded diffractive optics element 40 is done by pressing it into position with a piston that presses it against the compound high n material 35. For optimum optical performance the diffractive optic element 40 can be made of low n material such as flour based polymers. Further decrease of refractive index while also inducing electric conductivity can be achieved by entering CNT to create a conductive compound material. For high transparency SWCNT is especially benign.

The front side 45 of the LED package 15 can be fitted with a refractive lens or a Fresnel lens or a diffractive lens to further enhance the control of the optical output. The LED package front side 45 can also be fitted with a Moth eye pattern that creates a graded refractive index compound material with air and high n material 35 that reduce Fresnel reflections in the transition from the LED package front side 45 and air or a waveguide with lower refractive index. The same moth eye structure principle can be applied to the embedded diffractive optics element 40 in order to reduce short wavelength Fresnel reflections that will induce unwanted backscatter of short wavelength light into the LED chip where the backscattered light is at risk to be recombined and decay into heat. The Moth eye structure feature size determines which wavelengths it will be visible for and therefore also efficient for. As the LED package 15 can be adapted to emit short wavelength light the moth eye patterning must be at a scale below the wavelength of the light in order not to interfere optically with the emitted light. The backscattered light from the embedded diffractive optics element 40 will most likely be incident on the sidewalls of the back part 5 of LED package 15 and through multiple reflections it will to a large extent be reflected past the LED chip 20 and back through the embedded diffractive optics element 40.

The emitted light from the LED chip 20 can be reflected towards the embedded diffractive optics element 40 by means of metallic mirror 25 and/or TIR mirroring created by use of a layer with low refractive index (in the following denoted “low n layer”) disposed upon the metallic mirror 25. The sidewalls of the back part 5 of LED package 15 can be formed as a cup with a parabolic design that redirect light from the LED chip 20 towards the embedded diffractive optics element 40. The low n layer can be a dielectric low n material 30 separating the metallic mirror 25 from the compound high n material 35. To enhance the TIR mirroring effect the sidewalls of the cup can feature ridges that creates angles where the light incident upon the transition between the compound high n material 35 and the dielectric low n material 30 are double reflected by TIR from one side to the other of a ridge and upwards towards the embedded diffractive optics element 40.

The dielectric low n material 30 should not be forming a thermal barrier so the choice of material should be a compromise between thermal, optical and reflective properties. Examples on good compromise materials include aluminium nitride, silicon dioxide, flour polymers etc. Ridges at the sides of the LED package 15 increases the total thermal transition area and thus the thermal conduction provided there are a difference of thermal conductivity between the compound high n material and the back part 5 of LED package 15 and the metallic mirror 25.

The metallic mirror 25 may serve as electric connection to one side of the LED chip 20 by introducing an opening or several openings in the dielectric low n material 30. Incident angles on the dielectric low n material 30 below the critical angle light will pass through and be reflected by the metallic mirror 25 or be Fresnel reflected. Good metallic mirrors 25 are up to 99% reflective so the combined efficiency of the TIR, Fresnel and mirror reflection will be in excess of 99%, which will lower, reflection loses and the associated heat generation by absorption. Both the metallic mirror 25 and the dielectric low n materials 30 can be sputtered onto the surface of the back part 5 of the LED package 15.

To avoid short circuiting the electric circuitry connecting to the LED chip 20 the LED chip 20 connect through the opening or the openings in the dielectric low n material 30 by means of a drop of the compound high n material 35 where the diamonds are doped with Boron and or CNT or metals or metal ions or alternatively through a metallic mirror 25. Surrounding the electric conductive material or the metallic mirror 25 connecting to the LED chip 20 a compound high n material 35 with dielectric properties is deposited to avoid short-circuiting the LED chip 20. The deposition of the materials can be done using print techniques that may include inkjet printing, transfer printing or the like. Heat curing, short wavelength curing or two component curing can do curing of the materials used to connect electrically to the LED chip 25. The dielectric compound high n material 35 enhances optical output from the sidewalls of the LED chip 20 and the sidewalls of the cup ensures that all out coupled light is predominantly TIR reflected upwards.

The LED package 15 can be based on a catadioptric design where several TIR reflecting surfaces in conjunction with several embedded diffractive optics elements 40 and refractive optics surface on the LED package front side 45 combine to focus the light emission into a desired direction as for instance into a waveguide. The moth eye anti Fresnel reflection effect can alternatively be obtained by introducing several graded refractive indices layers in the optical pathway. The moth eye compound refractive index layer can be introduced to the exiting surface as a means of re-circulating unwanted high angles such that they do not exit the LED package 15.

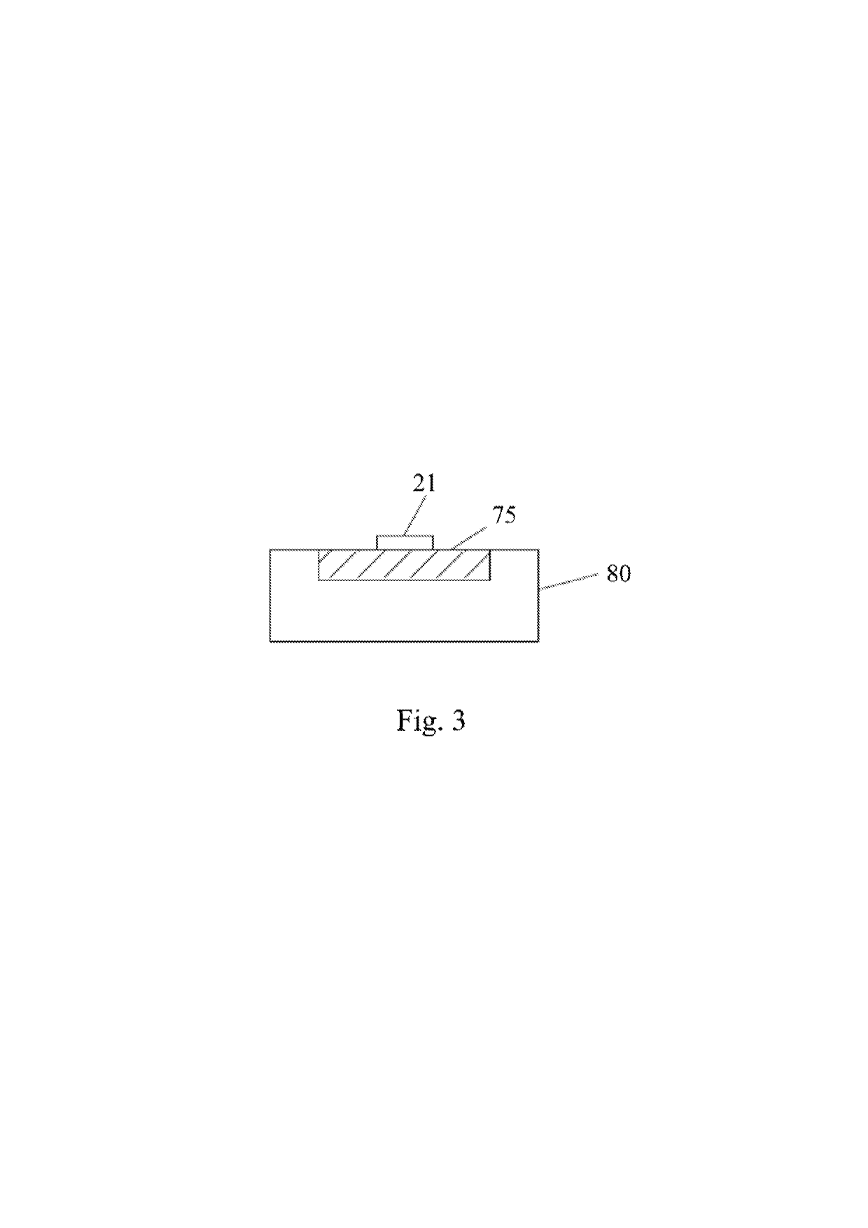

FIG. 3 shows an embodiment of an anisotropic heat transfer means according to a second aspect of the invention. The heat transfer means comprise a high n material 75, which in the preferred embodiment is material of the type described above and denoted high n material 35. The heat transfer means further comprises a heat sink 80, the high n material 75 being arranged on or (as shown) in the heat sink 80. The heat transfer means is adapted to be arranged on a surface of a semiconductor device 21 opposite an emitting or absorbing surface of the semiconductor device 21.

Such a heat transfer means may be used in connection with any type of semiconductor device, whether adapted for emitting or absorbing electromagnetic energy, particularly light. Such semiconductor devices include, but are not limited to, LEDs, OLEDs and any kind of photovoltaic cell, particularly photovoltaic cells of the type employing the principle of concentrating photovoltaics (CPV).

In the following it will be described as an example how a semiconductor based light source according to the invention may be provided with heat transfer device according to the invention. The example will be given by means of a semiconductor based light source in the form of the LED package 15 according to FIG. 1, in which the back part 5 is modified.

The back part 5 of the LED package 15 is moulded with high accuracy reproduction principles and the material chosen can be opaque as long as it is highly thermally conductive, whereas the desired electric conductivity can be applied by introducing a metallic mirror 25 as the connecting principle. The back part 5 of the LED package 15 can be made of a compound material comprising materials with a high thermal conductivity and as it can be opaque the CNT fill factor can be large and the requirement for transparent diamond nanodust particles with feature size below the wavelength of the LED chip 20 can be relaxed such that cheaper grades not usable for the compound high n material 35 can be employed. The same approach with aligning the CNT according to the electric field lines described for the compound high n material 35 to the front of the LED chip 20 can be employed. CNT is an approximately five times better thermal conductor than diamond provided the CNT is aligned on the long end along the desired direction of the heat transfer. The high efficient heat transfer along the aligned CNT spread the heat from the concentrated point where the semiconductor is located to a larger heat sink 10 where the thermal conductivity may be smaller because the cross section of the heat transferring area is increased to maintain high total thermal conduction.

As it can be difficult to create perfect match to the thermal expansion curve for gallium nitride (GaN) or indium gallium nitride (InGaN) crystals, a polymer such as silicone rubber with a large thermal expansion but a weak thermal expansion modulus can be utilized and stabilized by a strong thermal stabile diamond like carbon layer deposited to the surface of the back part 5 of the LED package 15 such that the back part 5 of the LED package 15 is effectively immobilized under thermal stress. In order to forge a strong thermal connection between the back part 5 of the LED package 15 and the heat sink inside the application where the packaged LED is utilized can be connected through use of a thermally conductive compound material and the transition to the LED package can feature a borderline with increases surface area to allow maximal thermal transmission to exterior heat sink.

By connecting to the entire front and back of the LED chip 20 the electric field lines inside the LED become evenly distributed and the generation of photons, recombination into electrons and phonons that decay into heat also becomes evenly distributed which ensures that the mean temperature of the LED chip 20 also becomes evenly distributed with less hot spots where degradation of the LED chip 20 are more readily initiated.

LED chip integrity will through the wider electric field pathway be preserved much better and the lifetime of the LED chip 20 will be increased and/or it will be possible to drive the LED chip 20 harder with higher current flow. Exiting photons and heat more effectively will reduce droop, which affects LED's negatively. To that end also exiting phonons from the LED chip 20 by bonding it to materials that feature same characteristics such that there are not acoustic transition barrier will relieve the LED chip 20 of an internal heat source. The exited phonons can be absorbed and thus transformed into heat at another point of the system design such as the embedded diffractive optics element 40 that is created from a material with properties different from the LED chip 20.

System integrity is adversely affected by thermal expansion of the various parts because InGaN and GaN are fragile crystals. Good match to thermal expansion and/or use of materials with low modulus of expansion such as for instance silicone rubber as a base material for the compound high n material 35 and/or use of diamond as founding crystal for epitaxial growth of the LED chip 20 crystal are possible design options for optimizing system integrity with respect to thermal expansion. On a system basis direct bonding with uniform electric field lines, thermal integrity enhancing design measures, optimized out-coupling of photons, reduced backscatter of emitted photons, optimized out-coupling of phonons and optimized out-coupling of heat enables higher junction temperatures, higher efficiency which in turn combined result in higher achievable output capacity in relation to energy input (Im/W), chip area (Im/chip-area) and cost of production and/or sale (Im/ [symbol] ).

Smaller LED chips 20 require less high cost compound high n material 35 with optical properties so the Im/ [symbol] cost can be impacted positively by using multiple LED chips inside the same package. Also, the distance from the embedded diffractive optics element 40 to the LED chip 20 impacts the amount of materials used.

Alternatively to the described type of electric connection ordinary wire bonding can be employed. Solder points can be created where convenient by bringing the anode and cathode into electric contact with any point of the exterior of the LED package 15 by means of conductive and dielectric separation.

In an embodiment the LED chip 20 is connected to the metallic mirror 25 through a perforated dielectric low n material 30 via a conductive compound high n material 35 surrounded by an insulating dielectric compound high n material 35 and the dielectric low n material 30 is a low n film that allow plano mount of LED chip 20 and vacuum forming into the cup formed by the back part 5 of LED package 15.

The LED chip 20 can have any geometric form desired but the preferred form is hexagonal. Usually wafers are dices by scribing but alternative ablation laser cutting can be employed. The hexagonal form reduce the cutting distance, resembles a round form most of all geometric figures that can be packed densely without spacing, allow minimal distance from the point where photons are generated till the edge or surface they exit from, optimize the number of LED chips 20 that can be contained on a single wafer, makes optical design of cup and embedded diffractive optics element 40 more efficient. Similar to the LED chip 20 the embedded diffractive optics element 40 and the back part 5 of LED package 15 can have any desired geometric form that is advantageous for specific embodiments of the present innovation from an optical point of view or due to form factor or other considerations. The design is also feasible with a trench with multiple LED chips 20 or a cluster of cups with multiple LED chips 20 or single cups with multiple LED chips 20.

All the principles described for short wavelength emitting LED's are applicable for LED's that emit in longer wavelength including visible spectrum, NIR and IR provided the embedded diffractive optics elements 40 is designed according to the wavelength of emitted light.

The increased thermal mass of the LED chip 20 provided by the abutting compound high n material 35 and the back part 5 of LED package 15 will increase the performance obtainable for pulsed LED chips 20.

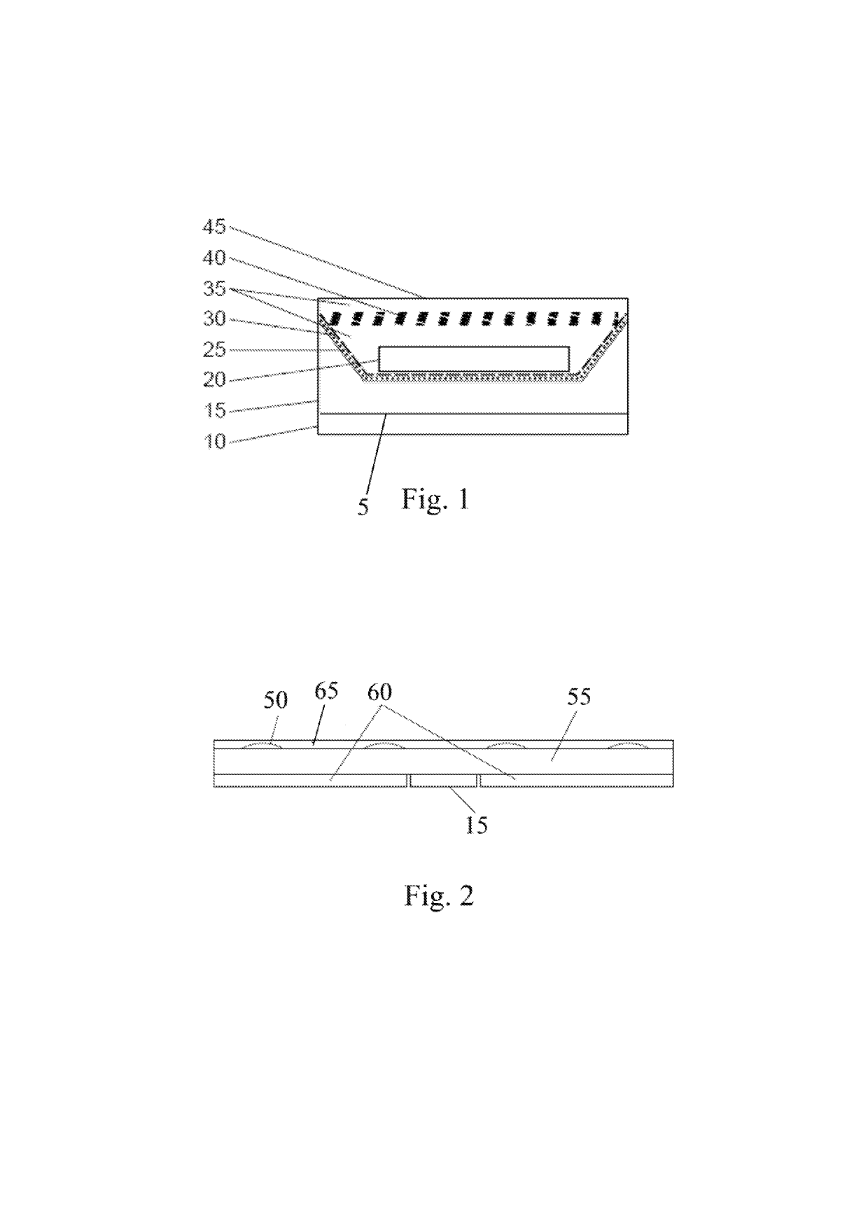

FIG. 2 shows a semiconductor based light source according to the invention in the form of a LED package 15 of the type described above connected to a waveguide device which is formed as a layered structure or laminate comprising a metallic member, an inner low n layer 65, a high n transparent waveguide 55, phosphors dots 50 and an outer protective low n layer 60 with an opening allowing the packaged LED chip 20 to connect optically to the transparent waveguide layer 55.

In principle it is, however, possible to connect any type of semiconductor based light source, including LED chips and LED packages of other types, e.g. conventional LED packages, than the LED package 15 described herein, to a waveguide of the type shown in FIG. 2

The packaged LED chip 20 forming the LED package 15 is thus adapted to connect optically and thermally to a waveguide device comprising a metallic member, a sputtered metallic mirror, a reflective and diffusive inner low n layer 65, a high n transparent waveguide layer 55, a layer of phosphor dots 50 and a protective transparent outer low n layer 60 with an opening allowing the packaged LED chip 20 to connect optically to the transparent waveguide layer 55.

The metallic mirror layer is optional and the inner low n layer 65 may be transparent, colour filtering or opaque. The outer low n layer 60 may be index matched to the waveguide layer 55 or high n without disrupting the waveguide layer 55 because the surrounding air will act as the low n material defining the outer boundaries of the waveguide.

By connecting a semiconductor based light source, preferably according to the invention in the form of a LED package 15 of the type described above, to a waveguide device as described above an in connection with FIG. 2, a bulb may be provided.

The outer low n material 60 enables such a bulb to emit light as intended even when submersed in water and prevents the bulb from emitting unintended wavelengths where fingerprint, insect dropping etc. create frustrated TIR. Also the outer low n material 60 protect the phosphors from oxygen and moist that otherwise would deteriorate the phosphors more rapidly.

A supplementary filter layer (not shown) that reflect specific wavelength such as the short wavelength light emitted from the LED chip 20 may be inserted above the phosphor dots 50 in order to control unwanted quantities of short wavelength light. This filter is especially relevant for possible short wavelength emitters that emit potentially harmful UVA or UVB.

A thermal conducting transparent high n diamond layer can protect the mirror layer and at the same time enhance Fresnel reflection in the transition from the low n layer to the diamond layer.

Due to the low n materials 60 and 65 on both sides of the high n waveguide layer 55 short wavelength light from the LED chip 20 emitted into the waveguide device will be trapped by TIR until it impinges on phosphor dots 55 that convert the light to longer wavelength light. For general lighting the phosphor dots 55 can comprise various phosphors that convert into various visible wavelengths. The phosphor dots 55 can be printed with variable fill factor such that the bulb will emit even intensity of visible light or the phosphor dots can be printed onto the bulb such that they form coloured text, graphics or illuminate specific parts of the bulb surface while others do not emit. Heat and photons generated by the phosphors will be emitted remote from the LED chip 20 such that the LED chip 20 will be protected from performance degrading heat and photons. Likewise the intense heat and irradiation from the LED chip 20 will be guided away from the phosphor dots so they can be operated safely below temperatures and irradiation intensities where they are damaged.

The metallic member can be plane, a bulb like sphere, a disc, a tube or any geometrical form required to create any desired form factor lamp. The desired bulb form factor can be added to a socket with a form factor matching standard bulb form formats and comprising electronic circuitry adapted to drive high output LED chip 20 or several high output LED chips 20. In a preferred embodiment the metallic member is blow-moulded aluminium shaped to match the form format of a standard E27 bulb. The sphere is completed by an extra aluminium part that is pressed or soldered or glued into the blow-moulded aluminium part. Alternatively cast aluminium parts can be used to create the bulb shape. Prior to applying the metallic mirror the bulb inner core can be polished to reduce surface irregularities that can send redirect light inside the waveguide device into unwanted bounce angles below the critical angle. Any other spherical standard bulb form formats are easily made in the same way.

Alternatively to having a metallic member the waveguide device laminate can be provided as a film and then attached to suitable three dimensional surfaces including formed metallic surfaces or polymeric surfaces. The film approach allows the system to cut to shapes and to be produced at a low roll to roll cost. In one embodiment the film approach can be combined with film packaging of the LED chip 20 and thus enable thin packages with large emitting area that can include a multitude of LED chips 20 attached to the same film.

Alternatively to having a LED chip 20 packaged as described one or more side emitting LED chips can be employed. Most of the light emitted from a side emitting LED will enter the waveguide device in suitable angles above the critical angle and the light that does not enter the waveguide device above the critical angle can be moved inside the waveguide device by normal reflectance and or a phosphor print in the perimeter of the of the LED chip 20 below a low n layer can convert short wavelength light to visible light that is radiated from areas of the bulb not covered by an outer mirroring layer.

The production processes for application of the layers are based on sputtering, print, spin coating, dip coating, spray coating and preferably UV-curing or alternatively heat curing or two component curing. After the first sputtered mirror layer with or without a protective diamond coating has been applied the remaining production processes are all based on printing/dispensing the materials on to specific desired areas of the surface of the metallic member. This production process is akin to printed electronics techniques and similarly achieves high-speed high volume production capacity relative to investment in production equipment. The printing technique makes the technique very versatile as everything can be controlled by altering parameters such has viscosity, UV intensity, exposure time, spin speed, print pattern, print amount and print material surface wettability.

Alternatively to having an outer waveguide device as in the embodiment described above, an inner waveguide device can be employed to create lamps that emit from a more pointed filament. In this embodiment the embedded diffractive optical elements 40 are adapted to focus light through a pipe formed by the heat sink encasing the transparent compound in front of the LED chip 20. The heat sink 10 is extended or connected to a larger heat sink to form a heat radiation form that transfer heat by primarily convection to the surrounding air. The surface area in contact with air can be increased through ridges or through channels inside the heat sink that are formed by creating the heat sink from two parts with spiraling air channels such that the heating of the air inside the heat sink create a strong draft that increase the dissipation of heat through convection. The two parts of the outer heat sink are preferably made from cast aluminium and the surfaces can selectively at different areas be treated with various methods that for instance increase reflectivity for use as a reflector by adding a sputtered mirror layer and a protective coating, achieve desired colours by paint or anodization or increase heat irradiation by black paint. Light emission through the heat sink is possible by incorporating holes in the line of vision towards the emitting part of the lamp. The above design can form many types of LED based bulbs including standard bulbs form formats such as the PAR 38. The emitting “filament” is clad with phosphor print where it is desired to emit light. The light output can be made directional by including diffractive optic elements in front of the phosphors. This method can increase system efficiency and directional output control by limiting the amount of photons that impinge on the reflective sides of the heat sink.

A low n cladding is added to protect the filament from potentially damaging insect droppings and fingerprints protects the phosphors. Such a low n cladding may be a Teflon AF layer or it may be another type of layer such as a nanoporous layer. A protective low n cladding above the waveguide layer and phosphors serves as an oxygen barrier and as an optical shield against FTIR due to for instance insect droppings and fingerprints.

Various modifications and alterations of the invention will be apparent to those skilled in the art without departing from the spirit and scope of the invention. It should be understood that the invention is not limited to illustrative embodiments set forth herein.

One set of itemized embodiments is given below:

Embodiment 1. The light source according to the first aspect of the invention, further comprising a heat sink connected to the back part.

Embodiment 2. The light source according to the first aspect of the invention, wherein one or more semiconductor light sources are mounted on a waveguide device built as a laminate comprising a metallic member, an inner low n layer, a high n transparent waveguide, phosphors dots and an outer protective low n layer.

Embodiment 3. The light source of embodiment 2, wherein said inner low n layer is transparent, colour filtering or opaque, and/or the outer protective low n layer is index matched to the waveguide or to the high n layer.

Embodiment 4. The light source of embodiment 2, further comprising a metal mirror layer arranged between the metal member and the inner low n layer.

Embodiment 5. The light source of embodiment 2, further comprising a diffusive low n layer.

Embodiment 6. The light source of embodiment 2, wherein the phosphor dots comprise a varying fill factor and control coloured text, graphics, illumination areas and intensity of emittance.

Embodiment 7. The light source according to the first aspect of the invention, wherein one or more packaged semiconductor chips are mounted to a waveguide passing through a metallic heat sink adapted to dissipate heat via convection.

Embodiment 8. The light source of embodiment 7, wherein the metallic heat sink comprising spiraling air channels such as to increase the area of the heat sink in contact with air and through draft pull more air past the surface of the heat sink.

Embodiment 9. The light source of embodiment 8, wherein at least one of the metal parts of the metallic heat sink is a blow-moulded or a cast aluminum part.

Embodiment 10. The light source according to the first aspect of the invention, wherein one or more packaged semiconductor chips are mounted on a waveguide built as a laminate comprising an inner mirror, a low n transparent layer, a high n transparent waveguide, phosphors dots and an outer protective low n layer.

Embodiment 11. The light source according to the first aspect of the invention, further comprising a compound material comprising materials with a high refractive index and a high thermal conductivity on said back part.

Embodiment 12. The light source of embodiment 11, wherein the compound material comprising materials with a high refractive index and a high thermal conductivity comprises at least one of silicon carbide (SiC), diamond nanoparticles, Boron doped diamond nanoparticles, carbon nanotubes (CNT), single walled carbon nanotubes (SWCNT).

Embodiment 13. The light source of embodiment 11, wherein the compound material comprising materials with a high refractive index and a high thermal conductivity is made of a polymer which is made thermally conductive by means of incorporation of at least one of silicon carbide particles (SiC), diamond nanoparticles, Boron doped diamond nanoparticles, carbon nanotubes (CNT), single walled carbon nanotubes (SWCNT), ceramic particles or metallic particles such as particles of indium-tin-oxide (ITO), copper, silver, gold or the like.

Embodiment 14. The light source of embodiments 12 or 13, wherein the CNT and/or SWCNT are aligned with the electric field lines connecting to the point where the semiconductor chip is mounted.

Embodiment 15. The light source according to the first aspect of the invention, wherein said at least one semiconductor chip is any one of a LED-chip, an OLED-chip, a side emitting LED-chip.

Embodiment 16. A heat transfer means for a semiconductor device,

said heat transfer means being adapted to be arranged on a surface of a semiconductor device opposite an emitting or absorbing surface of said semiconductor device, and

said heat transfer means being an anisotropic heat transfer means and comprising a compound material comprising materials with a high refractive index and a high thermal conductivity.

Embodiment 17. The heat transfer means of embodiment 16, further comprising a heat sink.

Embodiment 18. The heat transfer means of embodiment 16, wherein the compound material comprising materials with a high refractive index and a high thermal conductivity comprises at least one of silicon carbide (SiC), diamond nanoparticles, Boron doped diamond nanoparticles, carbon nanotubes (CNT), single walled carbon nanotubes (SWCNT), ceramic particles or metallic particles such as particles of indium-tin-oxide (ITO), copper, silver, gold or the like.

Embodiment 19. The heat transfer means of embodiment 16, wherein the compound high n material is made of a polymer which is made thermally conductive by means of incorporation of at least one of silicon carbide particles (SiC), diamond nanoparticles, Boron doped diamond nanoparticles, carbon nanotubes (CNT), single walled carbon nanotubes (SWCNT).

Embodiment 20. The heat transfer means of embodiments 18 or 19, wherein the CNT and/or SWCNT are aligned with the electric field lines connecting to the point where the semiconductor device is mounted.

Embodiment 21. The heat transfer means of embodiment 19, wherein the polymer is any one of epoxy, silicone and silane.

Embodiment 22. A semiconductor based light source mounted on a waveguide device built as a laminate comprising a metallic member, an inner low n layer, a high n transparent waveguide, phosphors dots and an outer protective low n layer.

Embodiment 23. The light source of embodiment 22, wherein said inner low n layer is transparent, colour filtering or opaque, and/or the outer protective low n layer is index matched to the waveguide or to the high n layer.

Embodiment 24. The light source of embodiment 22, further comprising a metal mirror layer arranged between the metal member and the inner low n layer.

Embodiment 25. The light source of embodiment 22, further comprising a diffusive low n layer.

Embodiment 26. The light source of embodiment 22, wherein the phosphor dots comprise a varying fill factor and control coloured text, graphics, illumination areas and intensity of emittance.

Embodiment 27. The light source of embodiment 22, wherein one or more packaged semiconductor chips are mounted to a waveguide passing through a metallic heat sink adapted to dissipate heat via convection.

Embodiment 28. The light source of embodiment 27, wherein the metallic heat sink is made of two metal parts that form spiraling air channels such as to increase the area of the heat sink in contact with air and through draft pull more air past the surface of the heat sink.

Embodiment 29. The light source of embodiment 28, wherein at let one of the metal parts of the metallic heat sink is a blow-moulded or a cast aluminum part.

Embodiment 30. The light source of embodiment 22, wherein one or more packaged semiconductor chips are mounted on a waveguide built as a laminate comprising a pure roll to roll film, an inner low n layer, a high n transparent waveguide, phosphors dots and an outer protective low n layer.

1. A semiconductor based light source comprising:
a back part, a front side and at least one semiconductor chip having an emitting surface,
at least one reflective optical element being arranged below said at least one semiconductor chip,
a material with low refractive index (low n material) being disposed on a side of said reflective optical element facing said front side,
wherein said semiconductor based light source comprises on said front side a compound material with high refractive index (compound high n material) having at least one diffractive optical element embedded therein, such as to direct light incident on said diffractive optical element towards preferred directions.

2. (canceled)

3. The light source of claim 1, wherein the at least one diffractive optical element comprise Moth eye structures with pattern features being smaller than the wavelength of light emitted by said at least one semiconductor chip, which Moth eye structures create a graded compound refractive index at transitions between materials with high and low refractive indices, respectively, such as to reduce Fresnel reflections or induce Fresnel reflections.

4. The light source of claim 1, wherein the at least one diffractive optical element is imprinted on a low n film.

5. The light source of claim 1, wherein the at least one diffractive optical element is adapted to the wavelength(s) that is/are emitted from the semiconductor chip.

6. The light source of claim 1, wherein the at least one diffractive optical element is double sided.

7. The light source of claim 1, wherein the at least one diffractive optical element is placed above the emitting surface of the light source.

8. The light source of claim 1, wherein the at least one diffractive optical element is produced by use of a first nanoimprint lithography into a low n material that is cured and subsequently by means of a stamp pressed into a high n compound material, which is cured.

9. The fight source of claim 1, wherein the at least one diffractive optical element is produced by use of an at least single sided nanoimprint lithographed low n film embedded into a high n compound material.

10. The light source of claim 1, wherein the at least one reflective optical element is a mirroring optical element.

11. The light source of claim 10, wherein the mirroring optical element is a metallic mirror.

12. The light source of claim 1, wherein the mirroring optical elements are mirrors with total internal reflection (TIR) formed by a low n dielectric layer covering a metallic mirror creating a large refractive index transition from the compound high n material.

13. The light source of claim 1, wherein the compound high n material is made of a polymer which is made thermally conductive by means of incorporation of at least one of silicon carbide particles (SiC), diamond nanoparticles, Boron doped diamond nanoparticles, carbon nanotubes (CNT), single walled carbon nanotubes (SWCNT), ceramic particles or metallic particles such as particles of indium-tin-oxide (ITO), copper, silver, gold or the like.

14. The light source of claim 13, wherein the CNT and/or SWCNT are aligned with the electric field lines connecting to the point where the semiconductor chip is mounted prior to curing the packaging materials.

15. The light source of claim 13, wherein the silicon carbide particles, diamond particles and/or Boron doped diamond nanoparticles comprise diameters being smaller than the wavelength of light emitted by said at least one semiconductor chip.

16. The light source of claim 13, wherein the polymer is any one of epoxy, silicone or silane.

17. The light source of claim 1, wherein the mirrors have substantially upright ridges and angles above 90 degrees such as to enhance TIR mirroring of semiconductor chip emission upwards towards the at least one diffractive optical element.

18. The light source of claim 1, wherein a multitude of semiconductor chips are disposed inside a trench having mirroring surfaces that are substantially upright ridges and angles above 90 degrees such as to enhance TIR mirroring of semiconductor chip emission upwards towards the at least one diffractive optical element.

19. The light source of claim 1, wherein a multitude of semiconductor chips are disposed inside an essentially rounded extended shape having mirroring surfaces that are substantially upright ridges and angles above 90 degrees such as to enhance TIR mirroring of Semiconductor chip emission upwards towards the at least one diffractive optical element.

20. The light source of claim 1, wherein one or more semiconductor chips are mounted on a conductive reflective film with a dielectric layer that is perforated where the semiconductor chip is mounted.

21. The light source of claim 1, wherein one or more semiconductor chips are mounted on a conductive reflective film with a dielectric layer that is perforated where the semiconductor chip is mounted and electrically connected and laminated to a transparent film with thin reflective electrodes connecting to the semiconductor chip.

22-50. (canceled)
